(19) United States
(12) Patent Application Publication
(10) Pub. No.: US 2008/0221354 A1
(43) Pub. Date: Sep. 11, 2008

(54) Process for the Preparation of the Alkoxyamine 2-Methyl-2-[N-(Diethoxyphosphoryl-2,2-Dimethylpropyl)-Aminoxy] Propionic Acid

(76) Inventors: Jean-Luc Couturier, Lyon (FR); Didier Gigmes, Marseille (FR); Olivier Guerret, La Tour De Salvagny (FR); Yohann Guillaneuf, Marseille (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 11/596,306

(22) PCT Filed: May 10, 2005
(86) PCT No.: PCT/EP05/05799

§ 371 Date: Sep. 7, 2007

(30) Foreign Application Priority Data
May 13, 2004 (FR) 0405198

(51) Int. Cl. C07F 9/28

(52) U.S. Cl. 564/15

(57) ABSTRACT

The present invention relates to a process for the preparation of the alkoxyamine 2-methyl-2-[N-(diethoxy-phosphoryl-2,2-dimethylpropyl)aminoxy]propionic acid or of its salts comprising a stage of saponification of an azo compound in the presence of a base, a stage of photolysis of the salt resulting from the saponification stage in the presence of N-(tert-butyl)-1-diethylphosphono-2,2-dimethylpropyl nitroxide and optionally a stage of acidification of the salt of the alkoxyamine obtained on conclusion of the photolysis stage.

The alkoxyamine or its salts can be used as radical polymerization initiators.

The present invention relates to a process for the preparation of the alkoxyamine 2-methyl-2-[N-(diethoxy-phosphoryl-2,2-dimethylpropyl)aminoxy]propionic acid of formula (I):

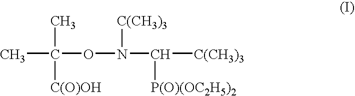

or of its salts from an azo compound and from a β-phosphorated nitroxide.

WO 2004/014926 discloses the synthesis of the alkoxyamine 2-methyl-2-[N-(diethoxyphosphoryl-2,2-dimethylpropyl)aminoxy]propionic acid according to an ATRA (Atom Transfer Radical Addition) reaction which uses a metal complex, in particular a copper complex. This process requires expensive purification stages to remove the metal compounds, such as washing operations with aqueous solutions, and generates large amounts of metal-comprising effluents.

U.S. Pat. No. 4,581,429 discloses the synthesis of an alkoxyamine other than the alkoxyamine of formula (I) by photolysis of an azo compound (4,4′-azobis(4-cyano-n-pentanol)) in the presence of di(t-butyl) nitroxide. However, the yield is low (43%) and the alkoxyamine obtained has to be purified by chromatography on a silica column, which cannot be extrapolated to the industrial scale.

The process for the preparation of the alkoxyamine (I) developed by the Applicant Company does not exhibit the disadvantages of the processes of the prior art:
the yield of alkoxyamine (I) is high: it is possible to obtain a quantitative yield with respect to the β-phosphorated nitroxide;
the process can operate at low temperature (<30° C.), which makes it possible in particular to retain the stability of the alkoxyamine (I) in solution, and proves to be more economical than the prior processes;
the purification of the alkoxyamine (I) is easy: by simple precipitation from the reaction mixture, the alkoxyamine (I) is obtained with a purity of greater than 99%;
the process is a 2- or 3-stage process, which stages can follow on successively from one another in the same reactor (one pot) when the solvent used in the 3 stages is the same and the intermediates do not require purification;
the process generates very little in the way of effluents and in particular no metal-comprising effluents;
the process can be adapted to a semicontinuous or continuous process.

The process according to the invention takes place in 2 or 3 stages according to the reaction scheme detailed below:

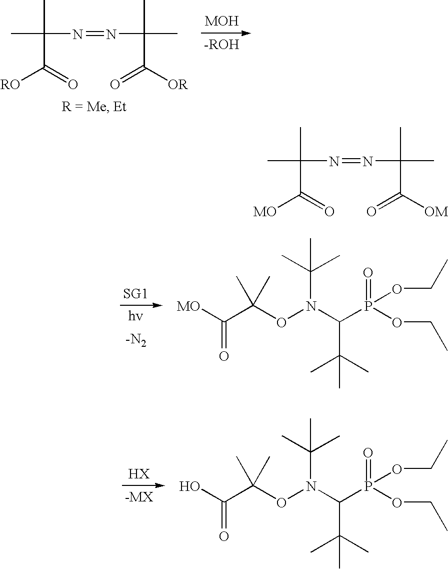

The first stage consists in saponifying the ester functional group of the azo compound of dialkyl azobisisobutyrate type, preferably dimethyl or diethyl azobisisobutyrate, in the presence of a base.

The dialkyl azobisisobutyrates can be prepared from azobisisobutyronitrile according to the process disclosed in WO 2000/042000. In the process according to the invention, it will not be departing from the scope of the invention to start from azobisisobutyronitrile and an alcohol (methanol, ethanol, and the like), as disclosed in WO 2000/042000, the dialkyl azobisisobutyrates thus being prepared in situ.

Preferably, the base of MOH type is sodium hydroxide, potassium hydroxide or ammonium hydroxide (M represents Na⁺, K⁺ or NH₄⁺).

The base/azo compound molar ratio is generally between 2 and 3 and the reaction is generally carried out at a temperature of between 0 and 40° C. in the presence of a solvent. The solvents which can be used can be mixtures of alcohols and water, acetonitrile and water or tetra-hydrofuran and water and preferably methanol/water or ethanol/water mixtures. The salt of the azo compound can be isolated by evaporation of the solvent or used as is in solution for the 2nd stage.

The 2nd stage consists in photolysing the salt of the azo compound in the presence of N-(tert-butyl)-1-diethylphosphono-2,2-dimethylpropyl nitroxide of formula (II):

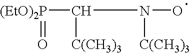

The nitroxide of formula (II) (abbreviated to SG1) can be prepared, for example, according to the processes disclosed in WO 2000/040526 or WO 2000/040550 or alternatively in WO 2002/048159.

The nitroxide (II)/azo compound molar ratio is generally between 0.5 and 5 and preferably between 1 and 2.5. Irradiation can, for example, be carried out using one or more mercury vapour lamps emitting radiation with a wavelength of between 200 and 600 nm. The reaction is generally carried out at a temperature of between 0 and 40° C. in the presence of a solvent. The solvents which can be used can be, as in the 1st stage, mixtures of alcohols and water, acetonitrile and water or tetrahydrofuran and water and preferably methanol/water or ethanol/water mixtures. Preferably, the solvents of the 1st and 2nd stages are identical.

It is preferable to carry out the reaction under an inert atmosphere (nitrogen, argon, and the like) and with vigorous stirring, either by sparging nitrogen via an atomizer head or using a recirculating pump. It is possible either to isolate the alkoxyamine in the salt form, by precipitation or by evaporation of the solvent, or to precipitate it in the acid form from the reaction mixture according to the 3rd stage.

The 3rd stage consists in acidifying the alkoxyamine salt in order to recover the alkoxyamine in the acid form. Preferably, the acid used is hydrochloric acid (in the gaseous or aqueous solution form) or sulphuric acid. Acidification is generally carried out at a temperature of between 0 and 30° C. The use of a solvent of alcohol(s) and water type, such as methanol/water or ethanol/water, as in the 1st and 2nd stages, is also preferred as it makes possible the precipitation of the alkoxyamine (I), which can be recovered by simple filtration.

The process of the present invention can be carried out batchwise, semicontinuously or continuously. In the case of a batch process, the three stages described above can follow on in succession, the solvent used being the same and the intermediates not requiring a purification stage.

The reaction mixture resulting from the 2nd stage can also be drawn off continuously and then subjected to acidification with a strong acid to precipitate the alkoxyamine (I), which can then be recovered, for example by filtration.

The alkoxyamine (I) thus prepared can be used as radical polymerization initiator, in particular as initiator for controlled radical polymerization; see, for example, U.S. Pat. No. 4,581,429, WO 2000/49027 and WO 2004/014926.

The following examples illustrate the invention without limiting it.

### EXAMPLE 1

a—Preparation of the Sodium Salt of DEAB

Diethyl azobisisobutyrate (DEAB) is prepared according to WO 00/42000.

25 g of DEAB (96.8 mmol) and 125 ml of methanol are introduced into a 500 ml glass reactor. 9.7 g of sodium hydroxide (242 mmol) are dissolved in 250 ml of water in a dropping funnel. The sodium hydroxide solution is run into the DEAB solution while maintaining the temperature at 25° C. and then reaction is allowed to take place at ambient temperature for 1 h.

b—Synthesis of the Alkoxyamine (I)

The nitroxide SG1 of formula (II) is prepared according to the example of WO 02/48159.

The photochemical reactor used is a jacketed glass reactor with a working volume of 1 l equipped with a jacketed lamp holder made of quartz. The lamp used is a high pressure mercury vapour lamp having a power of 700 W and emitting between 240 nm and 580 nm with a radiation maximum at 366 nm (reference TQ718 from Heraeus). Stirring is provided by sparging with nitrogen via an atomizer head.

The DEAB sodium salt solution prepared above is introduced into the photochemical reactor described above and then 9.5 g of nitroxide SG1 (32.3 mmol), dissolved in 125 ml of methanol, are added. The reaction mixture is brought to 10° C. and degassed by sparging with nitrogen for 15 min, and then irradiation is begun. The reaction is maintained at 10° C. under nitrogen sparging for 5 h (until the reaction mixture has discoloured).

The reaction mixture is then poured into 2.5 l of water comprising 20 ml of 37% hydrochloric acid (647 mmol) . The white powder formed is filtered off, washed with pentane and then dried under vacuum. 11.5 g of alkoxyamine (I) are obtained in the form of a white solid (yield=93%).

The product is characterized by ¹H, ¹³C and ³¹P NMR. The results are in agreement with those given in WO 2004/014926 (Example 1).

The elemental analysis (empirical formula C₁₇H₃₆NO₆P) gives the following results:

| | Element | | |
|---|---|---|---|
| | C | H | N |
| %, theoretical | 53.53 | 9.51 | 3.67 |
| %, experimental | 53.66 | 9.49 | 3.67 |

### EXAMPLE 2

The preparation is carried out as in Example 1, except for the modification of the sodium hydroxide/DEAB ratio (3 instead of 2.5), of the DEAB/nitroxide SG1 ratio (2.3 instead of 3) and of the photolysis temperature (20° C. instead of 10° C.).

| DEAB (mmol) | NaOH (mmol) | SG1 (mmol) | T (° C.) |
|---|---|---|---|
| 96.8 | 290.4 | 42.1 | 20 |

15.6 g of alkoxyamine (I) are then recovered, i.e. a yield of 97%.

1. Process for the preparation of the alkoxyamine 2-methyl-2-[N-(diethoxyphosphoryl-2,2-dimethylpropyl)aminoxy]propionic acid of formula (I): 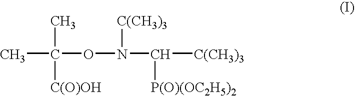
or of its salts, comprising:
saponification of an azo compound of the dialkyl azobisisobutyrate type, in the presence of a base;
photolysis of the azo compound salt resulting from the saponification stage in the presence of N-(tert-butyl)-1-diethylphosphono-2,2-dimethylpropyl nitroxide;
optionally acidification of the salt of the alkoxyamine obtained on conclusion of the photolysis stage; and
recovering the alkoxyamine or its salts.

2. Process according to claim 1, characterized in that, in the saponification stage, the base/azo compound molar ratio is between 2 and 3, the temperature is between 0 and 40° C. and use is made of a solvent which is preferably selected from of alcohols and water, acetonitrile and water or tetrahydrofuran and water.

3. Process according to claim 1, characterized in that, in the photolysis stage,
the nitroxide/azo compound molar ratio is between 0.5 and 5,
photolysis is carried out using one or more lamps emitting radiation with a wavelength of between 200 and 600 nm,
the temperature is between 0 and 40° C.,
use is made of a solvent which is selected from mixtures of alcohols and water, acetonitrile and water or tetrahydrofuran and water,
photolysis is carried out under an inert atmospheres and
photolysis is carried out with stirring.

4. Process according to claim 1, characterized in that, in the acidification stage, the temperature is between 0 and 30° C. and use is made of a solvent selected from mixtures of alcohols and water.

5. Process according to claim 1, characterized in that it is carried out batchwise, semicontinuously or continuously.

6. Process according to claim 1, characterized in that said base is selected from sodium hydroxide, potassium hydroxide or ammonium hydroxide.

7. Process according to claim 1, characterized in that said acidification of the salt of the alkoxyamine is with an acid selected from hydrochloric acid, in the gaseous or aqueous solution form, or sulphuric acid.

8. Process according to claim 2, characterized in that said solvent is selected from methanol/water or ethanol/water.

9. Process according to claim 3, characterized in that said nitroxide/azo compound molar ratio is between 1 and 2.5.

10. Process according to claim 3, characterized in that said solvent is selected from methanol/water or ethanol/water.

11. Process according to claim 3, characterized in that said solvent of said photolysis stage is the same as the solvent of said saponification stage.

12. Process according to claim 4, characterized in that said solvent is selected from methanol/water or ethanol/water.

13. Process according to claim 4, characterized in that said solvent of said photolysis stage is the same as the solvent of said saponification stage.
